(19) United States
(12) Patent Application Publication
(10) Pub. No.: US 2014/0285798 A1
(43) Pub. Date: Sep. 25, 2014

(54) COLORATION MEASURING APPARATUS

(71) Applicant: SEIKO EPSON CORPORATION, Suwa-shi (JP)

(72) Inventor: Teruyuki NISHIMURA, Matsumoto-shi (JP)

(73) Assignee: SEIKO EPSON CORPORATION, Suwa-shi (JP)

(21) Appl. No.: 14/223,291

(22) Filed: Mar. 24, 2014

(30) Foreign Application Priority Data
Mar. 25, 2013 (JP) 2013-061549

(51) Int. Cl. G01J 3/50

(52) U.S. Cl. CPC G01J 3/502
USPC 356/300

(57) ABSTRACT

A coloration measuring apparatus includes a wavelength variable interference filter, an imaging unit which receives light which transmits the wavelength variable interference filter, a storage unit which stores types of test paper, and reference color data obtained by associating colors showing a coloration state of the test paper, a spectrometry unit which measures a spectral spectrum of the test paper from light received by the imaging unit when the wavelength of the light which transmits the wavelength variable interference filter is sequentially switched, and a quantitative analysis unit which performs quantitative measurement of a sample based on the spectral spectrum measured by the spectrometry unit and the reference color data.

### BACKGROUND

1. Technical Field

The present invention relates to a coloration measuring apparatus.

2. Related Art

In the related art, there is known a coloration measuring apparatus which quantitatively measures a coloration state of a reagent by bringing a liquid sample into contact with test paper holding the reagent (for example, see JP-A-2001-349834).

In the coloration measuring apparatus disclosed in JP-A-2001-349834, a reagent insertion port is provided on a box-like apparatus main body, the test paper to which a reagent for measuring is applied to have 3 rows and 3 columns, is inserted into the reagent insertion port, and light is emitted with respect to the test paper from a light source to image light which transmits the test paper with a color CCD. A color of a coloration substance is analyzed by performing an image process of a color image imaged by the color CCD, and the coloration state is quantitatively measured.

In the apparatus disclosed in JP-A-2001-349834, a color image is imaged by the color CCD, and quantitative measurement of the coloration state is performed by the image process of the imaged color image. However, the color of the color image which is imaged using the color CCD is determined based on the light in limited wavelength regions such as R (red wavelength region), G (green wavelength region), and B (blue wavelength region), and accurate light intensity with respect to each wavelength is difficult to detect. Therefore, the apparatus is not appropriate for high precision analysis.

In JP-A-2001-349834, it is necessary to receive the light which transmits the test paper, and the types of the usable test paper are limited.

### SUMMARY

An advantage of some aspects of the invention is to provide a coloration measuring apparatus capable of performing a high precise quantitative measurement of a coloration state regardless of types of test paper.

An aspect of the invention is directed to a coloration measuring apparatus that measures a coloration state of test paper holding a reagent which shows a color reaction by contact with a sample, the apparatus including: a light dispersion unit to which light from the test paper which receives natural light or light from a light source is incident, and which selects light having a predetermined wavelength from the incident light, and changes the predetermined wavelength; a light receiving unit which receives light having a wavelength selected by the light dispersion unit; a storage unit which stores reference color data showing a coloration state of the test paper; a color measurement unit which measures a color of the test paper from light rays having a plurality of wavelengths received by the light receiving unit; and an analysis unit which performs quantitative measurement of the sample based on the color measured by the color measurement unit and the reference color data.

In the aspect of the invention, the light rays having a plurality of wavelengths from the light from the test paper are dispersed by the light dispersion unit, and the respective dispersed light rays are received by the light receiving unit to acquire light intensity with respect to each wavelength. Accordingly, it is possible to measure accurate color (spectral spectrum) with respect to the coloration state of the color-reacted test paper, by the color measurement unit with high precision. Therefore, it is possible to determine the coloration state of the test paper based on the analyzed color and the reference color data by the analysis unit with high precision, and it is possible to perform the quantitative measurement of the sample based on the coloration state with high precision.

In the aspect of the invention, any light from the test paper may be received, and both the light which transmits the test paper and the light which is reflected by the test paper may be received. Thus, the types of the test paper are not limited as long as the reference color data with respect to the test paper is stored in the storage unit, and the quantitative measurement of the coloration state may be performed.

In the coloration measuring apparatus according to the aspect of the invention, it is preferable that the coloration measuring apparatus further includes a light source unit which emits light with respect to the test paper.

With this configuration, the light source unit which emits light with respect to the test paper is included. Accordingly, it is possible to increase a light receiving amount of the light receiving unit by detecting light which is emitted from the light source unit to be reflected by or to transmit the test paper, and it is possible to analyze the spectral spectrum with higher precision.

In the coloration measuring apparatus according to the aspect of the invention, it is preferable that the coloration measuring apparatus further includes: a loading base on which the test paper is loaded; and a cover unit which covers the loading base and forms an internal space for disposing the test paper between the loading base and the cover unit, and the cover unit includes the light source unit, the light dispersion unit, and the light receiving unit on a surface facing the loading base.

With this configuration, the light is emitted with respect to the test paper on the loading base from the light source unit provided on the cover unit, and the reflected light thereof is received by the light receiving unit through the light dispersion unit. In such a configuration, by loading the test paper on the loading base and disposing the cover unit so as to face the loading base, it is possible to perform the quantitative measurement of the coloration state with respect to the test paper by the light source unit, the light dispersion unit, and the light receiving unit provided on the cover unit. That is, it is not necessary to perform focusing or adjustment of an imaging position by a user so that the light from the light source unit is emitted to the test paper or the reflected light is received by the light receiving unit, and it is possible to improve operability in the measurement of the coloration state.

In addition, the loading base for loading the test paper, and the cover unit are separately configured, and the respective configurations for performing the coloration quantitative measurement of the test paper are assembled in the cover unit. Accordingly, the coloration quantitative measurement may be performed without bringing the test paper into contact with the cover unit, and it is possible to not perform cleaning of the cover unit or to decrease cleaning frequency thereof.

In the coloration measuring apparatus according to the aspect of the invention, it is preferable that the coloration measuring appratus further includes a shielding unit which shields external light in the internal space from being incident to the inside.

With this configuration, since the external light is not incident to the internal space by the shielding unit, it is possible to perform high precision quantitative measurement with a reduced effect of noise due to the external light.

In the coloration measuring apparatus according to the aspect of the invention, it is preferable that the coloration measuring apparatus further includes a light incidence unit which introduces light incident to the light dispersion unit, and the light incidence unit includes a telecentric optical system.

With this configuration, since the light incident to the light dispersion unit becomes parallel light by the telecentric optical system, it is possible to receive light which is subjected to surface light dispersion by the light receiving unit, by the light receiving unit, and it is possible to acquire a spectroscopic image having a wavelength selected by the light dispersion unit.

Accordingly, it is also possible to detect a position in which the color reaction of the test paper occurs, based on the spectroscopic image. In addition, it is also possible to divide the test paper into a plurality of regions and to hold different types of reagents in respective regions, and in this case, it is possible to easily detect what kind of color reaction occurs with respect to which reagent, based on the spectroscopic image.

In the coloration measuring apparatus according to the aspect of the invention, it is preferable that the light incidence unit includes a magnifying optical system.

With this configuration, by disposing the light receiving unit on a rear portion of the magnifying optical system, it is possible to reduce a size of the light dispersion unit and to realize a miniaturized apparatus.

In the coloration measuring apparatus according to the aspect of the invention, it is preferable that the light dispersion unit is a wavelength variable Fabry-Perot etalon.

With this configuration, the wavelength variable Fabry-Perot etalon is used as the light dispersion unit. The Fabry-Perot etalon may be configured with a simple configuration in which only a pair of reflection films are disposed to face each other, and may easily change a spectroscopic wavelength by changing a gap dimension between the reflection films. Accordingly, by using such a wavelength variable Fabry-Perot etalon, it is possible to realize a miniaturized coloration measuring apparatus compared to a case of using a large-scale light dispersion unit, for example, an acousto-optical tunable filter (AOTF) or a liquid crystal tunable filter (LCTF).

As described above, in the configuration of including the light incidence unit including the magnifying optical system and the telecentric optical system, it is possible to further decrease a diameter dimension of the reflection films of the Fabry-Perot etalon. In this case, since surface accuracy of the reflection films is improved, it is possible to improve the precision of surface light dispersion, and it is possible to acquire a spectroscopic image with higher precision.

In the coloration measuring apparatus according to the aspect of the invention, it is preferable that the coloration measuring apparatus further includes a data acquisition unit which acquires the reference color data, and stores the acquired reference color data in the storage unit.

With this configuration, the data acquisition unit acquires the reference color data, and stores the acquired data in the storage unit. Herein, as a method of acquiring data of the data acquisition unit, for example, the data may be received through a network or the data is acquired through a storage medium (for example, a CD or a DVD, a USB card or an SD card, or the like). In addition, data which is manually input by a user may be used.

In the aspect of the invention, as described above, since it is possible to acquire accurate spectral spectrum with respect to the coloration state of the test paper, it is possible to perform the quantitative measurement with respect to various color reactions with high precision. Accordingly, as described above, by having the configuration of acquiring the reference color data and storing the data in the storage unit by the data acquisition unit, it is possible to increase the types of targets (test paper) to be analyzed, and it is possible to realize wide usage.

### BRIEF DESCRIPTION OF THE DRAWINGS

The invention will be described with reference to the accompanying drawings, wherein like numbers reference like elements.

FIG. 1 is a perspective view showing a schematic configuration of a coloration measuring apparatus according to one embodiment of the invention.

FIG. 2 is a diagram showing a schematic configuration of a cross section of a coloration measuring apparatus of the embodiment.

FIG. 3 is a block diagram of a coloration measuring apparatus of the embodiment.

FIG. 4 is a diagram showing a light path example of an incident light of the light incidence unit of the embodiment.

FIG. 5 is a plan view of a wavelength variable interference filter which is a light dispersion unit of the embodiment.

FIG. 6 is a cross-sectional view taken along line VI-VI of FIG. 5.

FIG. 7 is a diagram showing an absorption spectrum of water.

FIG. 8 is a flowchart showing a color reaction inspection method of a coloration measuring apparatus of the embodiment.

FIG. 9 is a diagram showing a schematic configuration of a coloration measuring apparatus of another embodiment.

### DESCRIPTION OF EXEMPLARY EMBODIMENTS

Hereinafter, one embodiment according to the invention will be described with reference to the drawings.

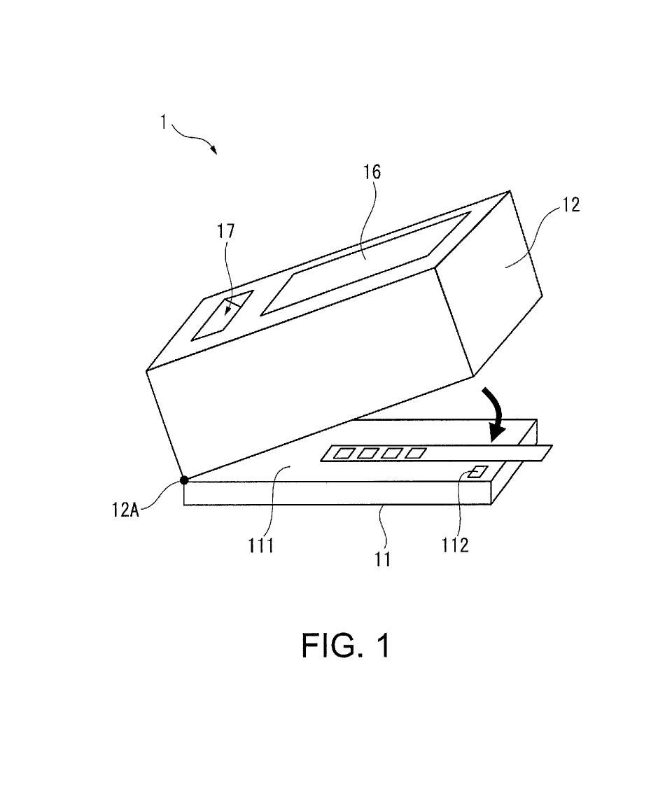

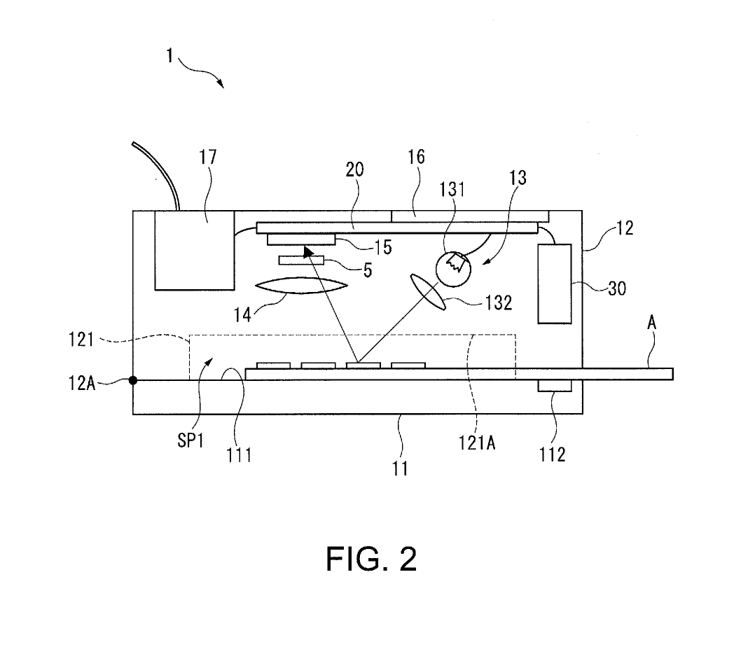

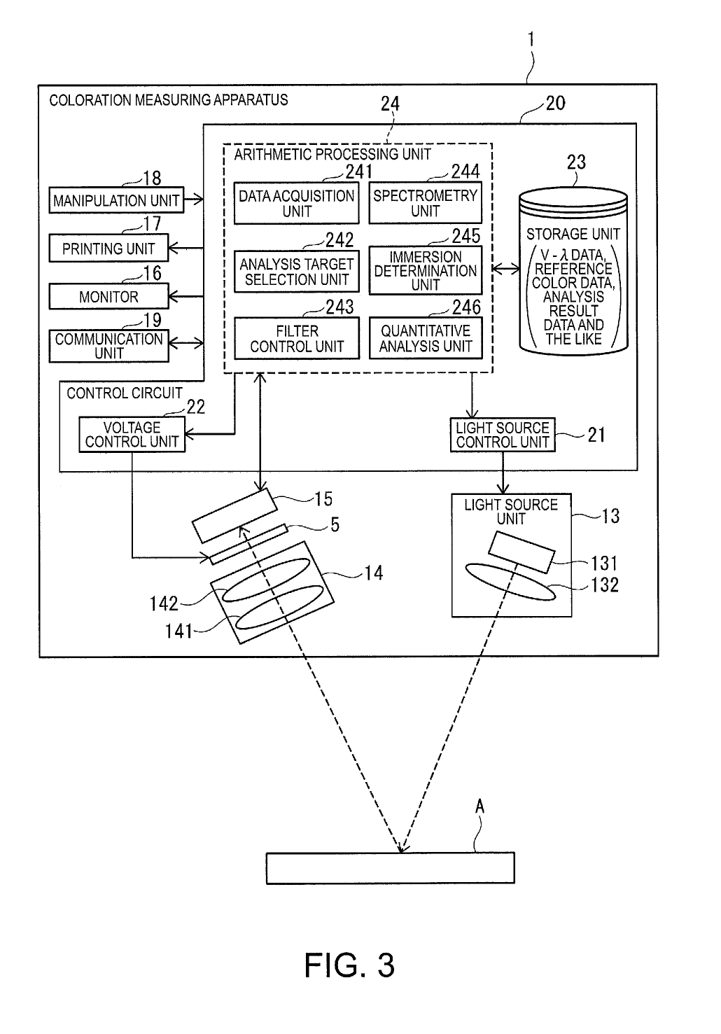

FIG. 1 is a perspective view showing a schematic configuration of a coloration measuring apparatus according to the embodiment and FIG. 2 is a diagram showing a schematic configuration of a cross section of the coloration measuring apparatus. FIG. 3 is a block diagram schematically showing the coloration measuring apparatus of the embodiment.

A coloration measuring apparatus 1 of the embodiment is an apparatus which detects a coloration state of test paper holding a reagent which shows a color reaction by contact with a liquid sample, and performs quantitative measurement of the liquid sample. The coloration measuring apparatus 1 is also used for quantitative analysis of components included in a general solution, in addition to quantitative analysis of components included in urine, blood, or body fluid.

As shown in FIG. 1, the coloration measuring apparatus 1 includes a loading base 11, and a main body unit 12 (corresponding to a cover unit according to the invention) which is rotatably attached to the loading base 11.

As shown in FIG. 2, the main body unit 12 includes a recess 121 on a surface facing the loading base 11, and a light source unit 13 and a light incidence unit 14 are disposed on a bottom surface 121A of the recess 121. Herein, the main body unit 12 is attached to the loading base 11 so as to rotate around the rotation axis 12A, and by rotating the main body unit 12 to the loading base 11 side, an internal space SP1 for accommodating test paper A is formed by a loading surface 111 on the loading base 11 and the recess 121. The loading base 11 and the main body unit 12 are configured with a material having a shielding property, and external light is not incident to the internal space SP1 in a state where the main body unit 12 is rotated to the loading base 11 side to form the internal space SP1. That is, a surface in contact with the internal space SP1 of the loading base 11 and the recess 121 configures a shielding unit according to the invention.

As shown in FIG. 2, a wavelength variable interference filter 5 configuring a light dispersion unit according to the invention, and an imaging unit 15 configuring a light receiving unit according to the invention are disposed in the main body unit 12. In addition, a control circuit 20 which controls the wavelength variable interference filter 5, the light source unit 13, the imaging unit 15, and the like, and a battery 30 are provided in the main body unit 12. In the embodiment, the configuration example in which power is supplied to each configuration from the battery 30 through the control circuit 20 is shown, but it is not limited thereto, and the embodiment may be configured so that the power is supplied from a power source such as a home power source or the like.

As shown in FIGS. 1 and 2, a monitor 16 and a printing unit 17 are provided on a surface (upper surface) of the main body unit 12 on a side opposite the loading base 11. The monitor 16 displays various setting screens or guide screens for performing analysis, for example, and a screen showing analysis result data and the like, by the control of the control circuit 20. The printing unit 17 prints and outputs the analysis result data, for example, onto a printed matter (for example, surface of paper), by the control of the control circuit 20.

As shown in FIG. 3, a manipulation unit 18 and a communication unit 19 are provided in the main body unit 12.

The manipulation unit 18 outputs a manipulation signal in accordance with manipulation of a user to the control circuit 20. As the manipulation unit 18, for example, manipulation members such as buttons provided on a surface of the main body unit 12 may be included, the monitor 16 may be configured to function as a touch panel, or a separate manipulation member such as a keyboard or a mouse may be connected thereto.

The communication unit 19 includes a drive which can communicate with an external storage medium (various storage media, for example, a CD, a DVD, an USB memory, and an SD card) connected to the main body unit 12, for example, and acquires various data items such as reference color data which will be described later from the external storage medium. The communication unit may be configured so that various data items, for example, analysis result data can be stored in the connected external storage medium. The communication unit 19 includes an external connection unit (for example, a LAN) which can be connected to a network line, for example, Internet line. Under the control of the control circuit 20, the communication unit 19 acquires various data items such as the reference color data from the network line, and transmits the analysis result data or the like to a predetermined transmission destination (for example, server device provided in a medical institution).

The loading base 11 includes the loading surface 111 for loading the test paper A. The loading base 11 includes a detection sensor 112 which detects whether or not the internal space SP1 is blocked when the main body unit 12 is rotated to the loading base 11 side. Such a detection sensor may be configured, for example, to include a pin member which is provided to stand on the loading base 11 and to move in an axis direction, and a detection unit which detects a depressed amount of the pin member. In this case, the main body unit 12 is rotated to come in contact with the pin member, and if the pin member is depressed, the depressed amount thereof is detected by the detection unit. It is detected that the internal space is blocked when the detected depressed amount thereof is equal to or more than a predetermined value. The configuration of the detection sensor 112 is not limited to the configuration described above, and the blocking of the internal space SP1 may be detected by an optical sensor, for example.

### Configuration of Light Source Unit

The light source unit 13 turns on and off the light by control of a light source control unit 21 provided on the control circuit 20. The light source unit 13 includes alight source 131, an emission wavelength of which includes a wavelength for measurement and a wavelength for immersion determination, and a lens 132 which emits light which exits from the light source 131 to the upper portion of the loading base 11. The lens 132 is not limited to the configuration of including a single element, and a plurality of the lenses 132 may be included. Herein, the wavelength for measurement is a wavelength of light for performing the quantitative measurement of the coloration state of the test paper A and is, in the embodiment, a wavelength of visible light. The wavelength for immersion determination is a wavelength of light for determining an immersion state of the liquid sample with respect to the test paper A and is, in the embodiment, a wavelength of infrared light (near-infrared light).

For example, the light source 131 may be configured to include an infrared light source which emits light having the wavelength for immersion determination and a visible light source which emits light having the wavelength for measurement (for example, visible light), or may be configured by a light source which can emit light from the infrared light to the visible light (light having the wavelength for measurement and the wavelength for immersion determination). The light source 131 may also be configured to include a UV light source which emits light having an ultraviolet wavelength region. By including the UV light source, it is also possible to use a reagent which changes a color thereof (including fluorescence or the like) at the time of ultraviolet light emission, as an analysis target.

### Configuration of Light Incidence Unit

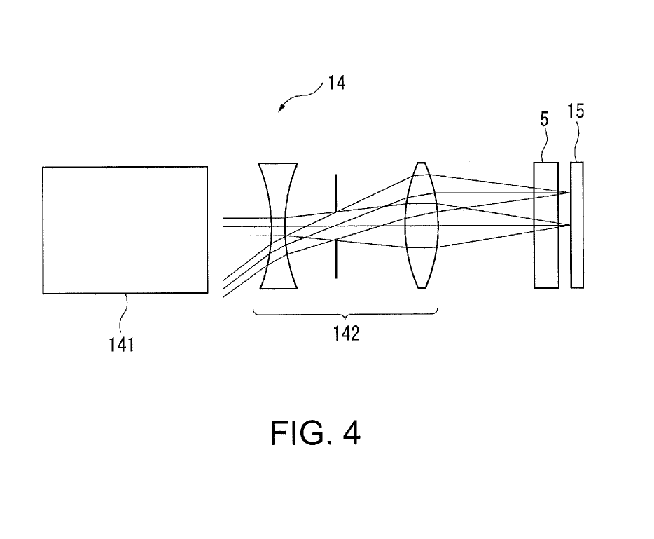

FIG. 4 is a diagram showing an example of a light path from the light incident unit to the imaging unit.

The light incidence unit 14 introduces the reflected light from the test paper A loaded on the loading base 11 to the imaging unit 15. The light incidence unit 14 includes a magnifying optical system 141 and a telecentric optical system 142.

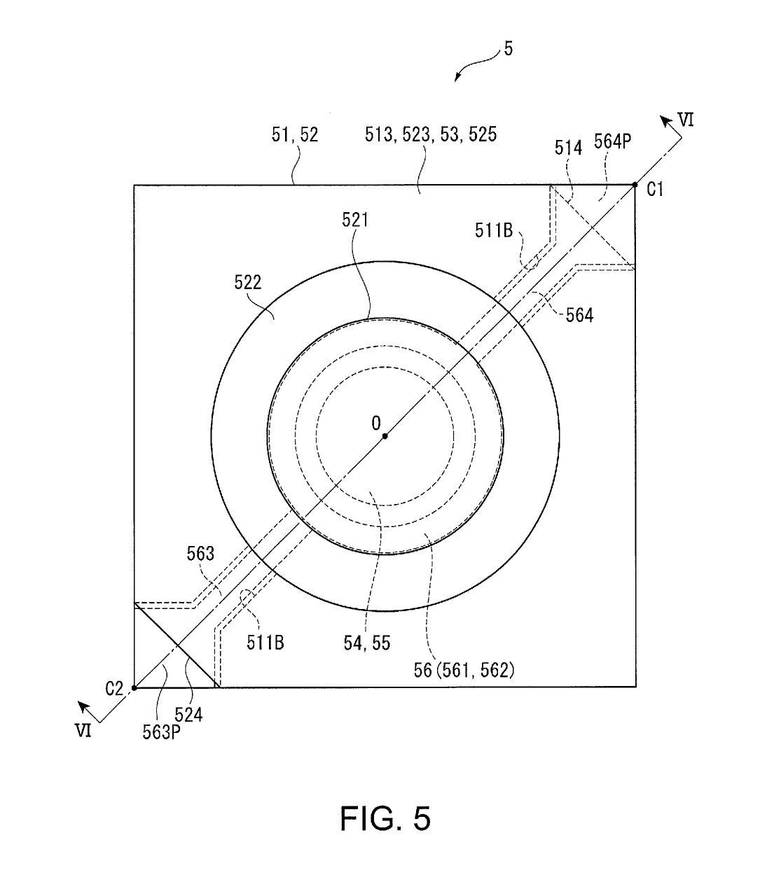

The magnifying optical system 141 is configured by a plurality of lenses, and images an image of the light from the loading base 11 by the imaging unit 15. At that time, each lens of the magnifying optical system 141 is configured so that the incident light on the loading base 11 in a predetermined imaging range is incident to a fixed reflection film 54 (see FIG. 5) and a movable reflection film 55 (see FIG. 5) of the wavelength variable interference filter 5 which will be described later.

The telecentric optical system 142 is configured with a plurality of lenses, sets an optical axis of the incident light in a direction parallel with a main light ray, and vertically emits light with respect to the fixed reflection film 54 or the movable reflection film 55 of the wavelength variable interference filter 5 which will be described later.

### Configuration of Wavelength Variable Interference Filter

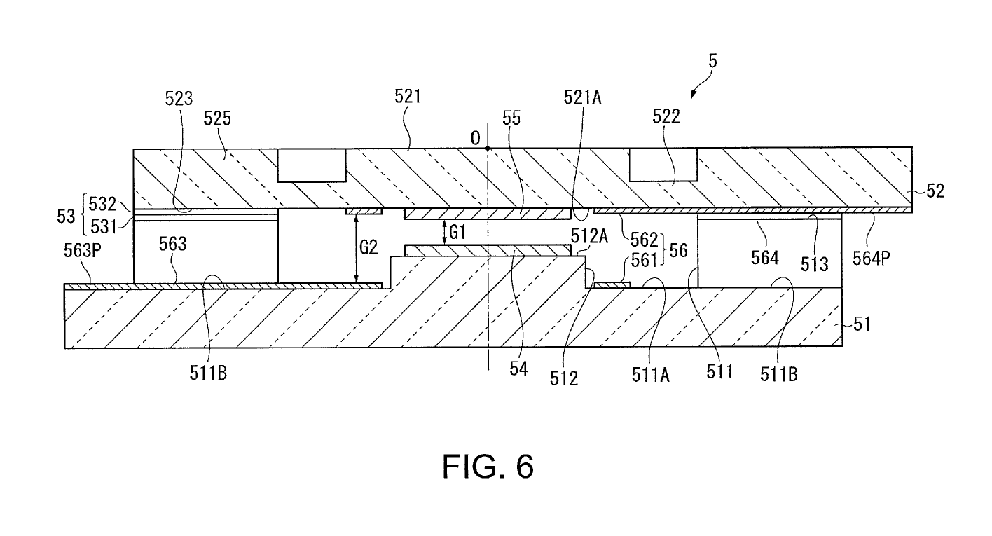

FIG. 5 is a plan view showing a schematic configuration of the wavelength variable interference filter. FIG. 6 is a cross-sectional view of the wavelength variable interference filter when the cross-sectional view is taken along line VI-VI of FIG. 5.

The wavelength variable interference filter 5 is a wavelength variable Fabry-Perot etalon. The wavelength variable interference filter 5 is, for example, an optical member having a rectangular plate shape, and includes a fixed substrate 51 which is formed to have a thickness dimension of, for example, approximately 500 μm, and a movable substrate 52 which is formed to have a thickness dimension of, for example, approximately 200 μm. Each of the fixed substrate 51 and the movable substrate 52 is formed with, for example, various glass items such as soda glass, crystalline glass, quartz glass, lead glass, potassium glass, borosilicate glass, alkali-free glass, or quartz crystal. The fixed substrate 51 and the movable substrate 52 are integrally configured by bonding a first bonding portion 513 of the fixed substrate 51 and a second bonding portion 523 of the movable substrate 52 to each other by a bonding film 53 (first bonding film 531 and second bonding film 532) configured with a plasma-polymerized film having siloxane as a main component, for example.

The fixed reflection film 54 is provided on the fixed substrate 51 and the movable reflection film 55 is provided on the movable substrate 52. The fixed reflection film 54 and the movable reflection film 55 are disposed to face each other with a gap G1 interposed therebetween. An electrostatic actuator 56 to be used for adjusting (changing) a dimension of the gap G1 is provided on the wavelength variable interference filter 5.

In a plan view (hereinafter, referred to as a filter plan view) as shown in FIG. 5 when the wavelength variable interference filter 5 is seen in a substrate thickness direction of the fixed substrate 51 (movable substrate 52), a plane center point O of the fixed substrate 51 and the movable substrate 52 coincides with a center point of the fixed reflection film 54 and the movable reflection film 55, and coincides with a center point of a movable portion 521 which will be described later.

### Configuration of Fixed Substrate

An electrode disposition groove 511 and a reflection film installation portion 512 are formed on the fixed substrate 51. The fixed substrate 51 is formed to have a larger thickness dimension than that of the movable substrate 52, and there is no bending of the fixed substrate 51 due to an electrostatic attractive force when voltage is applied between a fixed electrode 561 and a movable electrode 562, or internal stress of the fixed electrode 561.

A cut-out portion 514 is formed on an apex C1 of the fixed substrate 51, and a movable electrode pad 564P which will be described later is exposed to the fixed substrate 51 side of the wavelength variable interference filter 5.

In the filter plan view, the electrode disposition groove 511 is formed in a ring shape around the plane center point O of the fixed substrate 51. In the plan view, the reflection film installation portion 512 is formed to protrude to the movable substrate 52 side from the center portion of the electrode disposition groove 511. A groove bottom surface of the electrode disposition groove 511 is an electrode installation surface 511A on which the fixed electrode 561 is disposed. A protruded distal surface of the reflection film installation portion 512 is a reflection film installation surface 512A.

In addition, an electrode extraction groove 511B is provided on the fixed substrate 51 to be extended towards the apex C1 and an apex C2 on an outer periphery of the fixed substrate 51, from the electrode installation groove 511.

The fixed electrode 561 configuring the electrostatic actuator 56 is provided on the electrode installation surface 511A of the electrode disposition groove 511. More specifically, the fixed electrode 561 is provided in a region of the electrode installation surface 511A facing the movable electrode 562 of the movable portion 521 which will be described later. An insulating film for securing an insulting property between the fixed electrode 561 and the movable electrode 562 may be configured to be laminated on the fixed electrode 561.

A fixed extraction electrode 563 which is extended to the apex C2 direction from the outer periphery of the fixed electrode 561 is provided on the fixed substrate 51. An extended distal portion (portion of the fixed substrate 51 positioned at the apex C2) of the fixed extraction electrode 563 configures a fixed electrode pad 563P which is connected to a voltage control unit 22 of the control circuit 20 which will be described later.

In the embodiment, the configuration in which one fixed electrode 561 is provided on the electrode installation surface 511A is shown, but two electrodes may be provided so as to form a concentric circle around the plane center point O, for example (double electrode configuration).

As described above, the reflection film installation portion 512 is formed to have an approximately columnar shape having a smaller diameter dimension than that of the electrode disposition groove 511 on the same axis as the electrode disposition groove 511, and includes the reflection film installation surface 512A of the reflection film installation portion 512 facing the movable substrate 52.

As shown in FIG. 6, the fixed reflection film 54 is provided on the reflection film installation portion 512. As the fixed reflection film 54, a metallic film such as Ag, or an alloy film such as Ag alloy can be used, for example. A dielectric multilayer film having a high refraction layer as TiO₂ and a low refraction layer as SiO₂ may also be used. In addition, a reflection film obtained by laminating the metallic film (or alloy film) on the dielectric multilayer film, a reflection film obtained by laminating the dielectric multilayer film on the metallic film (or alloy film), or a reflection film obtained by laminating a single reflection layer (TiO₂ or SiO₂) and the metallic film (or alloy film) on each other, may also be used.

On the light incident surface (surface where the fixed reflection film 54 is not provided) of the fixed substrate 51, an antireflection film may be formed in a position corresponding to the fixed reflection film 54. This antireflection film may be formed by alternately laminating a low reflective index film and a high reflective index film on each other, and decreases a reflection index of the visible light on the surface of the fixed substrate 51 and increases transmittance thereof.

The first bonding portion 513 is configured with the surface on which the electrode disposition groove 511, the reflection film installation portion 512 and the electrode extraction groove 511B are not formed by etching from the surface of the fixed substrate 51 facing the movable substrate 52. The first bonding film 531 is provided on the first bonding portion 513, and the first bonding film 531 is bonded to the second bonding film 532 provided on the movable substrate 52, and accordingly, the fixed substrate 51 and the movable substrate 52 are bonded to each other as described above.

### Configuration of Movable Substrate

In the filter plan view as shown in FIG. 5, the movable substrate 52 includes the movable portion 521 having a circular shape around the plane center point O, a holding portion 522 which is on the same axis as the movable portion 521 and holds the movable portion 521, and a substrate outer periphery portion 525 which is provided on the outside of the holding portion 522.

As shown in FIG. 5, a cut-out portion 524 is formed on the movable substrate 52 to correspond to the apex C2, and the fixed electrode pad 563P is exposed when the wavelength variable interference filter 5 is seen from the movable substrate 52 side.

The movable portion 521 is formed to have a larger thickness dimension than that of the holding portion 522, and in the embodiment, for example, the movable portion is formed to have the same dimension as the thickness dimension of the movable substrate 52. In the filter plan view, the movable portion 521 is formed to have at least a larger diameter dimension than a diameter dimension of the outer periphery of the reflection film installation surface 512A. The movable electrode 562 and the movable reflection film 55 are provided on the movable portion 521.

In the same manner as the fixed substrate 51, an antireflection film may be formed on the surface of the movable portion 521 on a side opposite the fixed substrate 51. This antireflection film may be formed by alternately laminating a low reflective index film and a high reflective index film on each other, and decreases a reflection index of the visible light on the surface of the movable substrate 52 and increases transmittance thereof.

The movable electrode 562 faces the fixed electrode 561 with a gap G2 interposed therebetween, and is formed in a ring shape to have the same shape as the fixed electrode 561. The movable electrode 562 configures the electrostatic actuator 56 with the fixed electrode 561. A movable extraction electrode 564 which is extended towards the apex C1 of the movable substrate 52 from the outer periphery of the movable electrode 562 is provided on the movable substrate 52. An extended distal portion (portion of the movable substrate 52 positioned at the apex C1) of the movable extraction electrode 564 configures the movable electrode pad 564P connected to the voltage control unit 22.

The movable reflection film 55 is provided to face the fixed reflection film 54 with the gap G1 interposed therebetween, on a center portion of the movable surface 521A of the movable portion 521. As the movable reflection film 55, a reflection film having the same configuration as the fixed reflection film 54 described above is used.

In the embodiment, as described above, the example in which the gap G2 has a larger dimension than that of the gap G1 is shown, but it is not limited thereto. For example, the dimension of the gap G1 may be configured to be larger than the dimension of the gap G2 in a wavelength region of measurement target light, such as in a case of using infrared light or far-infrared light as the measurement target light.

The holding unit 522 is a diaphragm surrounding the vicinity of the movable portion 521, and is formed to have a smaller thickness dimension than that of the movable portion 521. Such a holding portion 522 is more easily bent than the movable portion 521, and can displace the movable portion 521 to the fixed substrate 51 side by a slight electrostatic attractive force. At that time, since the movable portion 521 has a larger thickness dimension and greater rigidity than those of the holding portion 522, even in a case where the holding portion 522 is pulled to the fixed substrate 51 side by the electrostatic attractive force, the shape of the movable portion 521 does not change. Accordingly, the movable reflection film 55 provided on the movable portion 521 is not bent either, and the fixed reflection film 54 and the movable reflection film 55 can be constantly maintained in a parallel state.

In the embodiment, the diaphragm-like holding portion 522 is used as an example, but it is not limited thereto. For example, beam-shaped holding portions may be provided at an equal angle interval around the plane center point O.

As described above, the substrate outer periphery portion 525 is provided in outside of the holding portion 522 in the filter plan view. The surface of the substrate outer periphery portion 525 facing the fixed substrate 51 includes the second bonding portion 523 facing the first bonding portion 513. The second bonding film 532 is provided on the second bonding portion 523, and as described above, by bonding the second bonding film 532 to the first bonding film 531, the fixed substrate 51 and the movable substrate 52 are bonded to each other.

### Configuration of Imaging Unit

As the imaging unit 15, an image sensor such as a charge coupled device (CCD) or a complementary metal oxide semiconductor (CMOS) can be used, for example. The imaging unit 15 includes a photoelectric element corresponding to each pixel, and outputs a spectroscopic image (image signal) having light intensity received by each photoelectric element as light intensity of each pixel to the control circuit 20.

### Configuration of Control Circuit

The control circuit 20 controls the entire operations of the coloration measuring apparatus 1.

As shown in FIG. 3, the control circuit 20 is configured to include the light source control unit 21, the voltage control unit 22, a storage unit 23, and an arithmetic processing unit 24.

The light source control unit 21 controls each light source 131 of the light source unit 13 and turns on and off of the light source 131.

The voltage control unit 22 applies driving voltage to the electrostatic actuator 56 of the wavelength variable interference filter 5 and switches the wavelength of the light which transmits the wavelength variable interference filter 5, under the control of the arithmetic processing unit 24.

The storage unit 23 is configured with a storage circuit such as a memory, and stores an operating system (OS) for controlling the entire operations of the coloration measuring apparatus 1, or programs or various data items for realizing various functions. The storage unit 23 includes a temporary storage for temporarily storing the imaged spectroscopic image, the analysis result data of the coloration state, or the like.

V-λ data which shows a relationship of the wavelength of the light which transmits the wavelength variable interference filter 5 with respect to the driving voltage applied to the electrostatic actuator 56 of the wavelength variable interference filter 5, is stored in the storage unit 23.

The reference color data obtained by associating the types of the test paper, the sample which can be detected by the reagent, the color (spectrum data) of the test paper (reagent) with respect to the coloration state of the test paper, and the like, is stored in the storage unit 23. The test paper on which the plurality of reagents are disposed in different positions, for example, may be used as the test paper, and in this case, the disposed positions of the reagents of the test paper are stored. The color of the test paper (reagent) with respect to the coloration state is a color when the liquid sample is immersed with respect to the test paper and the color reaction of the liquid sample and the reagent occurs, and the color with respect to the content of the sample is stored.

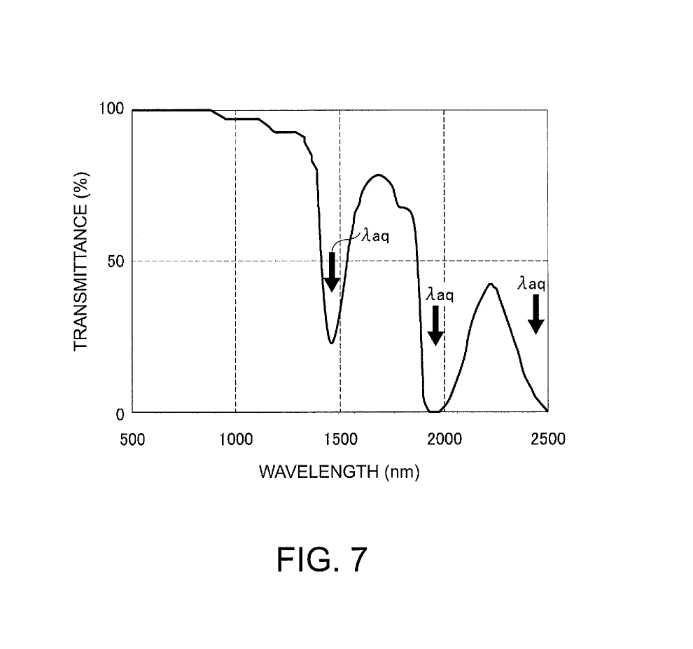

Further, data showing an absorption spectrum of water is stored in the storage unit 23. FIG. 7 is a diagram showing the absorption spectrum of water. As shown in FIG. 7, water has a broad light absorption property over a relatively wide wavelength range (for example, 100 nm to 300 nm), at a wavelength of about 1500 nm, about 2000 nm, and about 2500 nm. Accordingly, by acquiring the spectroscopic images at a predetermined wavelength interval over the near-infrared to infrared wavelength region, it is possible to determine the region containing water, that is, the region of the test paper in which the liquid sample is immersed.

The arithmetic processing unit 24 is configured with an arithmetic circuit such as a central processing unit (CPU), or a storage circuit, for example. The arithmetic processing unit 24 reads out and executes various programs stored in the storage unit 23, and accordingly functions as a data acquisition unit 241, an analysis target selection unit 242, a filter control unit 243, a spectrometry unit 244, an immersion determination unit 245, and a quantitative analysis unit 246, as shown in FIG. 3.

The data acquisition unit 241 acquires the reference color data from the network or the external storage medium through the communication unit 19 and stores the data in the storage unit 23. In detail, in a case where the connection with the external storage medium such as a universal serial bus (USB) memory or an SD card, or CD or DVD, is detected, the data acquisition unit 241 determines whether or not new reference color data which is not stored in the storage unit 23 is stored in the external storage medium, and in a case where the data is stored in the external storage medium, the data acquisition unit reads the reference color data to store the data in the storage unit 23. For example, the data acquisition unit is connected to the network line such as Internet at a constant frequency, and determines whether or not the new reference color data which is not stored in the storage unit 23 is open to the public on the network, and in a case where the data is opened to the public, the reference color data may be downloaded to be stored in the storage unit 23. Further, in a case where the reference color data is input with manipulation of the manipulation unit 18 by a user, the data acquisition unit 241 may acquire the reference color data to store the data in the storage unit 23.

The analysis target selection unit 242 selects types of the test paper for performing the quantitative measurement of the color reaction based on the manipulation of the manipulation unit 18 by a user.

The filter control unit 243 outputs a control signal which indicates to apply the driving voltage corresponding to a predetermined target wavelength, to the voltage control unit 22, by referring to the V-λ data stored in the storage unit 23.

The spectrometry unit 244 functions as a color measurement unit according to the invention, and acquires the spectroscopic images corresponding to each wavelength which is sequentially imaged by the imaging unit 15, when the driving voltage applied to the electrostatic actuator 56 is sequentially changed. The spectral spectrum of each pixel is calculated based on the light intensity of each pixel of the spectroscopic images.

As a method of calculating the spectral spectrum, for example, measurement spectrum matrix having each of the light intensities with respect to the plurality of measurement target wavelengths as a matrix element is generated, and a predetermined conversion matrix is caused to operate with respect to the measurement spectrum matrix, and accordingly the spectral spectrum of the light which is the measurement target is estimated. In this case, the plurality of sample light rays with the known spectral spectrum is previously measured by the imaging unit 15, and deviation between the conversion matrix is set so that the matrix caused the conversion matrix to operate to the measurement spectrum matrix generated based on the light intensity obtained by measurement, and the known spectral spectrum becomes a minimum value.

The immersion determination unit 245 determines whether or not there is a pixel in which the light intensity is decreased corresponding to the absorption spectrum of the water, from the spectral spectrum of each pixel of the spectroscopic image calculated as described above. In a case where there is a pixel corresponding to the absorption spectrum of the water, the pixel is detected as a location of the test paper (immersion region) at which the liquid sample is immersed.

The quantitative analysis unit 246 functions as an analysis unit according to the invention, and performs quantitative measurement of the coloration state of the test paper based on the spectral spectrum of each pixel in the immersion region and the reference color data stored in the storage unit 23.

### Color Reaction Inspection Method of Coloration Measuring Apparatus

Next, a color reaction inspection method using the coloration measuring apparatus 1 described above will be described with reference to the drawings.

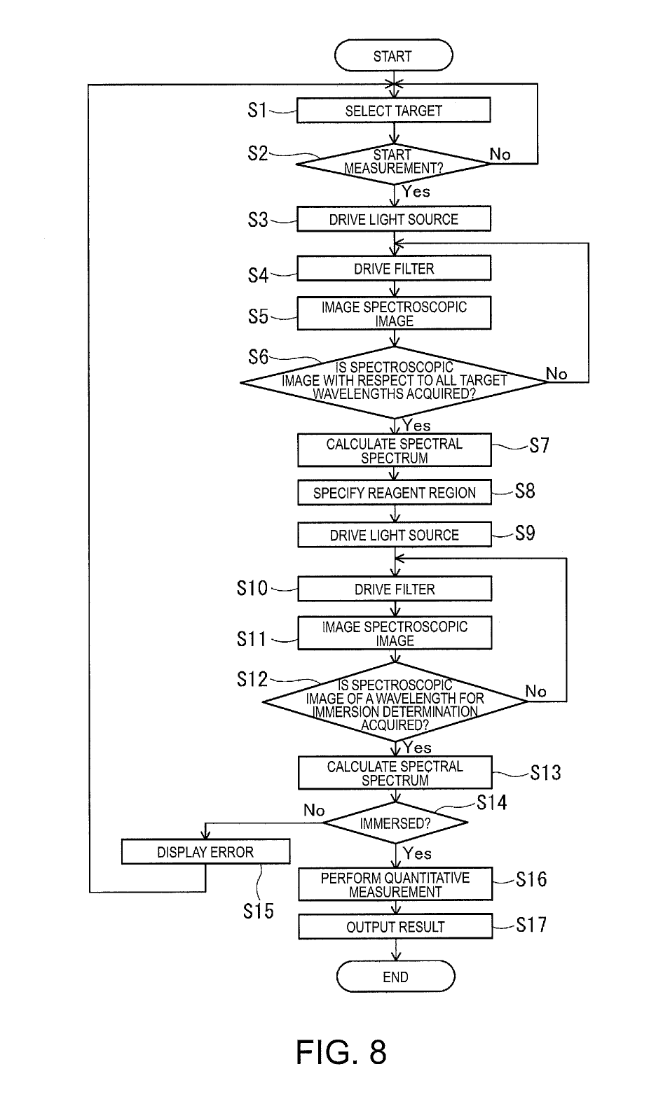

FIG. 8 is a flowchart showing the color reaction inspection method performed by the coloration measuring apparatus 1 of the embodiment.

In the coloration measuring apparatus 1 of the embodiment, first, the analysis target selection unit 242 of the arithmetic processing unit 24 displays a guide screen for selecting the test paper which is the measurement target on the monitor 16. The types of the test paper recorded in the reference color data stored in the storage unit 23 are read to be displayed on the monitor 16.

If the test paper which is the measurement target is selected with the manipulation of the manipulation unit 18 by a user, the analysis target selection unit 242 reads out the reference color data of the selected test paper A which is the measurement target (Step S1). After that, a quantitative measurement process of the coloration state of the test paper A is started. In the quantitative measurement process, first, the arithmetic processing unit 24 determines whether or not the apparatus is in a state to be able to start the inspection (Step S2).

For performing the quantitative measurement of the coloration state of the test paper A by the coloration measurement apparatus 1, first, a user loads the test paper A to which the liquid sample is immersed, on the loading surface 111 of the loading base 11, and rotates the main body unit 12 to the loading base 11 side. When the main body unit 12 comes in contact with the loading surface 111, a detection signal is input to the control circuit 20 from the detection sensor 112, and the arithmetic processing unit 24 starts the quantitative measurement process by the input of the detection signal. In a state where the detection signal is input, the internal space SP1 is shielded by the recess 121 of the main body unit 12 and the loading surface 111 of the loading base 11, and the external light is not incident thereto.

In Step S2, in a case where the detection signal is not input to the control circuit 20 (a case where it is determined as “No”), the state is turned to a standby state, the process returns to Step S1 and stands by in a state where the selection of the types of the test paper A can be selected.

Meanwhile, in Step S2, when the detection signal is input to the control circuit 20, the light source control unit 21 turns on the light source 131 (Step S3). At that time, in a configuration of including the infrared light source and the visible light source as the light source 131 of the light source unit 13, for example, the visible light source having the wavelength for measurement as emission wavelength region is turned on. In a configuration of including the light source 131 capable of emitting the light having the wavelength from the infrared light region to the visible light region by the light source 13, the light source 131 may be turned on.

The filter control unit 243 reads out the driving voltage corresponding to the target wavelength (wavelength for measurement), and outputs the control signal which indicates to apply the driving voltage to the electrostatic actuator 56, to the voltage control unit 22, by referring to the V-λ data stored in the storage unit 23 (Step S4). This leads to a state in which the gap dimension between the reflection films 54 and 55 of the wavelength variable interference filter 5 is changed and the light having the wavelength for measurement can transmit from the wavelength variable interference filter 5.

The light which transmits the wavelength variable interference filter 5 is received by the imaging unit 15, and the spectroscopic image corresponding to the wavelength for measurement is imaged (Step S5). The imaged spectroscopic image is output to the control circuit 20 and is stored in the storage unit 23.

After that, the filter control unit 243 determines whether or not there is any other unacquired spectroscopic image (Step S6). The unacquired spectroscopic image in Step S6 is a spectroscopic image corresponding to the wavelength for measurement for performing the quantitative measurement of the coloration state of the test paper A, and is a spectroscopic image having the wavelength which is predetermined wavelength interval (for example, interval of 10 nm) in the visible light region, for example.

In Step S6, in a case where there is a spectroscopic image which is not acquired yet (in a case where it is determined as “No”), the process returns to Step S4, and the unacquired spectroscopic image having the wavelength is acquired.

Meanwhile, in Step S6, in a case where it is determined that entire spectroscopic images are acquired (in a case where it is determined as “Yes”), the spectrometry unit 244 calculates the spectral spectrum (visible light region) of each pixel from the light intensity of each pixel of the acquired spectroscopic images corresponding to the plurality of wavelengths (Step S7). The calculated spectral spectrum is stored in the storage unit 23.

After that, the arithmetic processing unit 24 specifies the region of the test paper A in which the reagent is provided (reagent region), based on the calculated spectral spectrum with respect to each pixel (Step S8).

In detail, for example, the arithmetic processing unit 24 detects an outline portion of the test paper A based on the acquired spectral spectrum with respect to each pixel of the image. The reagent region with respect to the detected outline of the test paper A is detected from the data related to the types of the test paper of the reference color data which is selected in Step S1 and is read out by the analysis target selection unit 242. In addition, the reagent region may be directly detected from the acquired spectral spectrum of each pixel of the image, and the loading base (black), the test paper (white), and the reagent region (color reaction color) are detected, for example.

After that, the light source control unit 21 controls the light source unit 13 to emit the light to the test paper A (Step S9). At that time, in a case of using the light source unit 13 including the infrared light source and the visible light source, the infrared light source is turned on and the visible light source is turned off. In a case where the light source unit 13 is configured with the light source 131 including the wavelengths over the infrared light region and the visible light region, the light source 131 which is turned on in Step S3 may be continuously turned on.

The filter control unit 243 reads out the driving voltage corresponding to the target wavelength (wavelength for immersion determination), and outputs the control signal which indicates to apply the driving voltage to the electrostatic actuator 56, to the voltage control unit 22, by referring to the V-λ data stored in the storage unit 23 (Step S10).

Accordingly, the light which transmits the wavelength variable interference filter 5 is received by the imaging unit 15, and the spectroscopic image corresponding to the wavelength for immersion determination is imaged (Step S11). The imaged spectroscopic image is output to the control circuit 20 and is stored in the storage unit 23.

After that, the filter control unit 243 determines whether or not there is any other unacquired spectroscopic image (Step S12). In Step S12, the unacquired spectroscopic image is a spectroscopic image corresponding to the wavelength for immersion determination for performing the determination whether or not the liquid sample is immersed to the test paper A, and is a spectroscopic image having the wavelength which is predetermined wavelength interval (for example, interval of 10 nm) from the near-infrared wavelength region to the infrared wavelength region, for example.

In Step S12, in a case where there is a spectroscopic image which is not acquired yet (in a case where it is determined as “No”), the process returns to Step S10, and the unacquired spectroscopic image having the wavelength is acquired.

Meanwhile, in Step S12, in a case where it is determined that entire spectroscopic images are acquired (in a case where it is determined as “Yes”), the spectrometry unit 244 calculates the spectral spectrum (near-infrared wavelength region to the infrared wavelength region) of each pixel from the light intensity of each pixel of the acquired spectroscopic images corresponding to the plurality of wavelengths (Step S13).

Next, the immersion determination unit 245 determines whether or not the test paper A is immersed in the liquid sample (Step S14).

In detail, the immersion determination unit 245 compares the absorption spectrum of the water shown in FIG. 7 which is stored in the storage unit 23 and the spectral spectrum of each pixel calculated in Step S13, and determines whether or not there is the pixel in which the light intensity is decreased at the absorption spectrum wavelength λaq of water in the spectral spectrum of each pixel. That is, in a case where there is the pixel in which the absorption spectrum of the water is included in the spectral spectrum, the immersion determination unit 245 determines that there is a region in which the liquid sample is immersed in the test paper A, and in a case where there is no such a pixel, the immersion determination unit determines that there is no immersion region.

In Step S14, in a case where it is determined that there is no immersion region, the immersion determination unit 245 displays an error screen showing that the test paper is not immersed to the sample on the monitor 16, for example (Step S15), and the process returns to the process of Step S1.

In step S14, in a case where it is determined that there is the immersion region, the quantitative analysis unit 246 calculates the content rate of the sample with respect to the color (spectral spectrum) of the reagent region, based on the spectral spectrum calculated in Step S7 and the reference color data which is selected in Step S1 and is read out by the analysis target selection unit 242, with respect to each pixel in the reagent region specified in Step S8 (Step S16).

Herein, in a case where the test paper on which the plurality of types of reagents are disposed in different positions is selected as the type of the test paper recorded in the reference color data, each position on which the reagent of the test paper is disposed is stored in the reference color data. Accordingly, the quantitative analysis unit 246 may determine which position indicates the pixel corresponding to which reagent, among the pixels configuring the spectroscopic image based on the reference color data.

For example, as shown in FIG. 2, in a case where the different reagents are disposed along a line on the test paper A, the lined order of the reagents is stored in the reference color data. Accordingly, the spectral spectrum of the immersion region of the spectroscopic image is determined, and the pixel range including the pixels having the same spectral spectra is detected as the range in which one reagent is disposed, and accordingly it is possible to detect an inspection result with respect to each reagent.

After that, the control circuit 20 displays a measurement result calculated in Step S16 on the monitor 16 (Step S17). The control circuit 20 may output the measurement result to the printing unit 17 to output as a printed matter based on the manipulation of the manipulation unit 18 by a user. In addition, the control circuit 20 may transmit the result to a predetermined terminal device or a server device through a network such as Internet from the communication unit 19, or may be stored in the external storage medium connected to the coloration measuring apparatus 1, based on the manipulation of the manipulation unit 18 by a user.

### Operation Result of Embodiment

In the embodiment, the driving voltage to be applied to the electrostatic actuator 56 of the wavelength variable interference filter 5 is sequentially changed, and the spectroscopic image with respect to the plurality of wavelengths for measurement at an interval of 10 nm is acquired by the imaging unit 15, for example. The spectrometry unit 244 calculates the spectral spectrum of each pixel from the light intensity of each pixel of the spectroscopic image, and the quantitative analysis unit 246 performs the quantitative measurement of the coloration state of the test paper A based on the measured spectral spectrum and the reference color data stored in the storage unit 23.

In such a configuration, since it is possible to acquire the light intensity with respect to each wavelength by the wavelength variable interference filter 5, it is possible to determine the accurate color with respect to the coloration state of the test paper A, and it is possible to perform the quantitative analysis with high precision. In addition, it is not necessary to use the dedicated test paper as the test paper A, and it is possible to perform the quantitative measurement with respect to various types of the test paper A.

The coloration measuring apparatus 1 of the embodiment includes the light source unit 13 and emits the light to the test paper A on the loading base 11 from the light source 131 having the visible light. Accordingly, it is possible to acquire sufficient light intensity as the reflection light from the test paper A, and it is possible to improve the precision of the spectral spectrum and the precision of the quantitative measurement of the coloration state.

The coloration measuring apparatus 1 of the embodiment includes the loading base 11 which loads the test paper A and the main body unit 12 which is rotatably attached to the loading base 11, the recess 121 is provided on the main body unit 12, and the internal space SP1 is formed by the loading base 11 and the recess 121. In the internal space SP1, the light source unit 13, the light incidence unit 14, the wavelength variable interference filter 5, and the imaging unit 15 are provided on the bottom surface of the recess 121 facing the loading base 11.

In such a configuration, when the test paper A is loaded on the loading base 11 and the main body unit 12 is rotated to the loading base 11 side, the apparatus is in a state where the quantitative measurement of the coloration state of the test paper A can be performed, and it is possible to realize the improvement of manipulation efficiency.

The loading base 11 for loading the test paper A and the main body unit 12 are separate components from each other, and the light source 13, the wavelength variable interference filter 5, and the imaging unit 15 for performing the coloration quantitative measurement of the sample test A are embedded in the main body unit 12. The recess 121 is provided on the main body unit 12, and the test paper A and the main body unit 12 do not come in contact with each other.

Accordingly, the test paper A does not come in contact with the main body unit 12 (particularly recess 121) at the time of measurement, and the process such as cleaning of the main body unit 12 is not necessary.

In addition, the loading base 11 and the main body unit 12 are configured with a shielding member, and function as a shielding unit. Accordingly, the external light is not incident to the internal space SP1, it is possible to suppress the effect of noise due to the external light, and it is possible to improve the precision of the spectral spectrum and the quantitative measurement of the coloration state.

The detections sensor 112 is provided on the loading base 11, and outputs the detection signal when the main body unit 12 comes in contact with the loading base 11. The arithmetic processing unit 24 starts the quantitative measurement of the coloration state using the input of the detection signal as a trigger. In such a configuration, it is possible to more reliably suppress the incidence of the external light to the internal space SP1 at the time of measurement.

In the embodiment, a telecentric optical system 142 is included in the light incidence unit 14. Accordingly, the light reflected by the test paper A is incident to the reflection films 54 and 55 of the wavelength variable interference filter 5 as uniform and parallel light. Therefore, it is possible to perform surface light dispersion by the wavelength variable interference filter 5. That is, it is possible to cause the light having the target wavelength to transmit regardless of the incident position of the incident light to the reflection films 54 and 55, and it is possible to acquire the spectroscopic image with respect to the target wavelength, by imaging the light which is subjected to the surface light dispersion by the imaging unit 15.

The immersion determination unit 245 specifies the immersion region in which the liquid sample is immersed, based on the spectral spectrum (near-infrared wavelength region to the infrared wavelength region) of each pixel of the spectroscopic image, and the quantitative analysis unit 246 performs the quantitative analysis based on the spectral spectrum (visible light region) of the pixel with respect to the immersion region. Accordingly, it is possible to appropriately perform the quantitative analysis with respect to the location to which the liquid sample is attached. Even in a case of using the test paper on which the plurality of types of the reagents are disposed in different positions, if information (position of the reagents or the like) of the test paper is registered as the reference color data, it is possible to specify the position of each reagent of the test paper from the spectroscopic image. In this case, regardless of the types of the test paper, it is possible to perform the quantitative measurement of the coloration state with respect to each reagent disposed on the test paper, by performing the measurement once.

In the embodiment, the magnifying optical system 141 is included in the light incidence unit 14. It is possible to contract the reflection light from the test paper A to be incident to the reflection films 54 and 55 of the wavelength variable interference filter 5. Accordingly, it is possible to decrease the diameter dimension of the reflection films 54 and 55, and to promote the miniaturization of the wavelength variable interference filter 5. Since the area of the reflection films 54 and 55 can be decreased, it is possible to improve the surface precision of each of reflection films 54 and 55, to improve the spectroscopic precision of the wavelength variable interference filter 5, and to improve the measurement precision of the spectral spectrum and the measurement precision of the quantitative measurement of the coloration state.

In the embodiment, the wavelength variable interference filter 5 is used as a light dispersion unit. The wavelength variable interference filter 5 has the configuration in which the reflection films 54 and 55 are disposed to face each other, and the dimension of the gap G1 between the reflection films 54 and 55 is changed by the electrostatic actuator 56, it is possible to realize the miniaturization with the simple configuration and it is also possible to realize the miniaturization of the coloration measuring apparatus 1.

In the embodiment, the data acquisition unit 241 acquires the reference color data stored in the external storage medium or the reference color data on the network such as Internet through the communication unit 19 and stores the reference color data in the storage unit 23. In addition, it is also possible to acquire the reference color data based on the input manipulation of the manipulation unit 18 by a user. Accordingly, by newly registering the types of the test paper or the color of the coloration state with respect thereto, it is possible to sequentially add the types of the test paper in the quantitative measurement.

### Other Embodiment

The invention is not limited to the embodiment described above, and modifications and improvements within a range for achieving the aspect of the invention are included in the invention.

In the embodiment, the stationary configuration of including the loading base 11 and the main body unit 12 and forming the internal space SP1 which can accommodate the test paper A by the loading base 11 and the main body unit 12 is shown, but a portable coloration measuring apparatus may be used, for example.

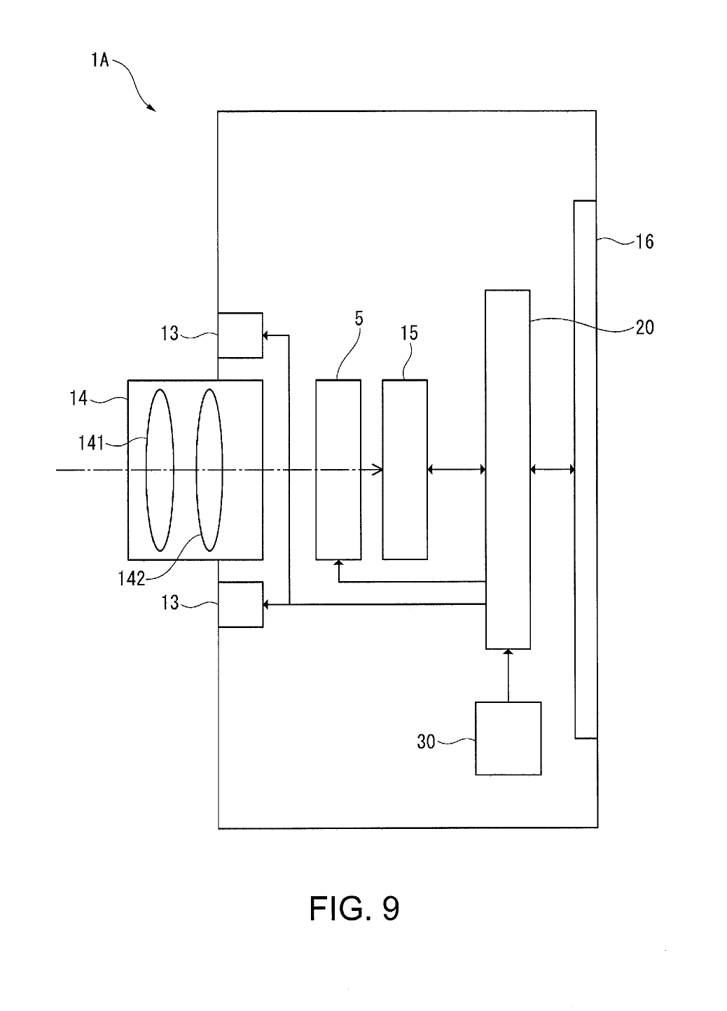

FIG. 9 is a diagram showing a schematic configuration of the portable coloration measuring apparatus of the other embodiment. In FIG. 9, the same reference numerals are denoted for the same configurations as those in the embodiment described above, and the description thereof will be omitted or simplified.

As shown in FIG. 9, a camera type apparatus can be used, for example, as the portable coloration measuring apparatus. In a coloration measuring apparatus 1A, each lens position of the light incidence unit 14 can be adjusted, and the measurement is started by performing focusing so that the color reaction portion of the test paper A is in an imaging range.

In the embodiment described above, after acquiring the spectroscopic image with respect to the wavelengths for measurement to calculate the spectral spectrum of each pixel of the test paper A, and specifying the reagent region, by the process from Step S3 to Step S8, the spectroscopic image of the wavelength for immersion determination is acquired to determine whether or not the test paper A is immersed in the liquid sample in the process from Step S10 to Step S14, but it is not limited thereto.

For example, from Step S3 to Step S6, the spectroscopic image of the wavelength for immersion determination may be also acquired in addition to the spectroscopic image of the wavelengths for measurement. In this case, in Step S6, it is determined whether or not the spectroscopic image having the entire target wavelengths (wavelengths for measurement and the wavelength for immersion determination) is acquired. In Step S6, in a case where it is determined as “Yes”, the spectral spectrum over the wavelengths for measurement and the wavelength for immersion determination of each pixel is calculated in Step S7. After that, the specifying of the reagent region of Step S8, and the immersion determination from Step S14 to Step S15 are performed.

Also in such processes, in the same manner as in the embodiment described above, it is possible to perform each process of the coloration quantitative measurement of the test paper A and the immersion determination of the test paper A, and the measurement procedure is shortened.

In addition, by performing the processes of Step S9 to Step S15 first, instead of the processes of Step S3 to Step S8, after determining whether or not the test paper A is immersed in the liquid sample from the spectral spectrum with respect to the wavelength region for immersion determination, the processes of Step S3 to Step S8 may be performed to specify the reagent region from the spectral spectrum with respect to the wavelength region for measurement, and processes of Step S16 and Step S17 may be performed.

Also in such processes, in the same manner as in the embodiment described above, it is possible to perform each process of the coloration quantitative measurement of the test paper A and the immersion determination of the test paper A, and it is possible to inform the abnormality with an error screen before acquiring the spectroscopic image of the wavelength for measurement, in a case where it is determined to have immersion abnormality.

In the embodiment, the example in which the reference color data is acquired by the data acquisition unit 241 from the external storage medium or the network, is shown, but in a case where the measurement target is decided in advance, for example, the data acquisition unit 241 may not be provided.

In the embodiment, the wavelength variable interference filter 5 is used as the light dispersion unit, but it is not limited thereto, and an AOTF or an LCTF may be used, for example. However, particularly in the portable coloration measuring apparatus 1A shown in FIG. 9, since miniaturization of the apparatus is desired, it is preferable to use a Fabry-Perot etalon as in the embodiment described above.

In the embodiment, the configuration in which the magnifying optical system 141 is provided in the light incidence unit 14 is shown, but it is not limited thereto. In this case, for acquiring the spectroscopic image, the size of the reflection films 54 and 55 of the wavelength variable interference filter 5 may be increased.

In addition, the configuration in which the telecentric optical system 142 is included is shown, but for example, in a case of performing the quantitative measurement of the coloration state with respect to a predetermined point of the test paper A, it is not necessary to acquire the spectroscopic image and the telecentric optical system 142 may not be included.

In the coloration measuring apparatuses 1 and 1A of the embodiment and FIG. 9, the example of including the light source unit 13 is shown, but it is not limited thereto. For example, the quantitative analysis of the coloration state may be performed using the external light. However, since the external light changes depending on the environment, it is preferable to perform the measurement using the light source unit described above for performing the measurement with higher precision.

In the embodiment, the example of determining the immersion state of the test paper A by the immersion determination unit 245 is shown, but it is not limited thereto.

For example, by assuming that the test paper A in which the sample liquid is immersed is used, the process of quantitative measurement of the colorations state (Step S3 to Step S8 and Step S16) may be performed without performing the process of the immersion determination (processes of Step S9 to Step S15).

In the embodiment described above, the light emitted from the light source unit 13 with respect to the test paper A loaded on the loading base 11 is reflected and transmits the wavelength variable interference filter 5 to image by the imaging unit 15. Meanwhile, the spectral spectrum of the light which transmits the test paper A may be measured and the quantitative measurement may be performed. In this case, for example, the loading surface 111 of the loading base 11 may be configured with glass or the like, and the light incidence unit 14, the wavelength variable interference filter 5, and the imaging unit 15 may be configured to be disposed on a lower portion of the loading surface 111.

In the embodiment, after calculating the spectral spectrum of the visible light region by the processes of Step S3 to Step S7, the reagent region is specified in Step S8, and then, the spectral spectrum of the near-infrared to the infrared wavelength region is calculated by the processes of Step S9 to Step S13, and the immersion state is determined in Step S14. Meanwhile, by performing the processes of Step S9 to Step S13 after the processes of Step S3 to Step S7, after measuring the spectral spectrum over the visible region and the infrared region, the specifying of the reagent region, the determination of the immersion state, and the quantitative measurement of the coloration state may be performed. In this case, it is not necessary for the light source control unit 21 to switch the infrared light source and the visible light source, and both of the infrared light source and the visible light source may be turned on to sequentially acquire the spectroscopic images corresponding to the visible region to the infrared region.

In the embodiment, the example in which the spectroscopic image at a predetermined wavelength interval over the infrared wavelength region and the near-infrared wavelength region is obtained in step S10 to step S12, and the pixel having the absorption spectrum of the water as shown in FIG. 7 is detected from the spectral spectrum of each pixel of the acquired spectroscopic image, in Step S13, is shown, but it is not limited thereto.

For example, the content rate of water in the test paper A may be calculated and in a case where the content rate of water is equal to or higher than a predetermined value, the test paper may be determined to be immersed. In this case, light intensity I₀ when performing the measurement with respect to a reference white plate such as MgO₂ is measured in advance. The immersion determination unit 245 acquires the light intensity I_{λaq} of each pixel of the spectroscopic image corresponding to the absorption spectrum wavelength λaq of water and calculates absorbance A_{λaq} by the following formula (I).

A_{λaq}=−log(I_{λaq}/I₀) (1)

In addition, correlation data (for example, standard curve) showing a correlation between the absorbance A_{λaq} of water and the content of water is previously stored in the storage unit 23. The immersion determination unit 245 analyzes the content rate of water of each pixel based on the calculated absorbance A_{λaq}, and the correlation data. As the analyzing method thereof, the analysis may be performed using a chemometric method used in the related art, and as the chemometric method, a method such as multi-regression analysis, main component regression analysis, or a partial least-squares method may be used. The immersion determination unit 245 detects the pixel having the analyzed content rate of water which is equal to or higher than a predetermined value, and determines the pixel as a pixel (immersion region) corresponding to the portion in which the liquid sample is immersed in the test paper A.

In a case of performing the immersion determination by the method described above, since the absorbance A_{λaq} corresponding to the absorption spectra of water may be acquired, the spectroscopic image corresponding to the absorption spectrum wavelength λaq of water may be acquired. Accordingly, as described above, it is not necessary to acquire all spectroscopic images at the predetermined wavelength intervals, and it is possible to reduce the time according to the acquisition process of the spectroscopic image.

In addition, a temperature detection sensor which detects a temperature or temperature distribution of the test paper A may be provided in the coloration measuring apparatus 1. In this case, a corrected value of the absorption spectrum wavelength λaq of water with respect to each temperature is stored in the storage unit 23 in advance. The immersion determination unit 245 may perform the process of correcting the wavelength λaq with respect to the temperature of the test paper A by applying the corrected value to the wavelength λaq. In such a configuration, even in a case where the absorption spectrum of water is changed depending on the temperature change, it is possible to appropriately determine the immersion state of the liquid sample based on the content rate of water.

In addition, the specific structure when realizing the invention can be suitably changed to another structure within a range for achieving the aspect of the invention.

The entire disclosure of Japanese Patent Application No. 2013-061549 filed on Mar. 25, 2013 is expressly incorporated by reference herein.

What is claimed is:

1. A coloration measuring apparatus that measures a coloration state of test paper holding a reagent which shows a color reaction by contact with a sample, the apparatus comprising:
a light dispersion unit to which light from the test paper which receives natural light or light from a light source is incident, and which selects light having a predetermined wavelength from the incident light, and changes the predetermined wavelength;
a light receiving unit which receives light having a wavelength selected by the light dispersion unit;
a storage unit which stores reference color data showing a coloration state of the test paper;
a color measurement unit which measures a color of the test paper from light rays having a plurality of wavelengths received by the light receiving unit; and
an analysis unit which performs quantitative measurement of the sample based on the color measured by the color measurement unit and the reference color data.

2. The coloration measuring apparatus according to claim 1, further comprising:
a light source unit which emits light with respect to the test paper.

3. The coloration measuring apparatus according to claim 2, further comprising:
a loading base on which the test paper is loaded; and
a cover unit which covers the loading base and forms an internal space for disposing the test paper between the loading base and the cover unit,
wherein the cover unit includes the light source unit, the light dispersion unit, and the light receiving unit on a surface facing the loading base.

4. The coloration measuring apparatus according to claim 3, further comprising:
a shielding unit which shields external light in the internal space from being incident to the inside.

5. The coloration measuring apparatus according to claim 1, further comprising:
a light incidence unit which introduces light incident to the light dispersion unit,
wherein the light incidence unit includes a telecentric optical system.

6. The coloration measuring apparatus according to claim 5,
wherein the light incidence unit includes a magnifying optical system.

7. The coloration measuring apparatus according to claim 1,
wherein the light dispersion unit is a wavelength variable Fabry-Perot etalon.

8. The coloration measuring apparatus according to claim 1, further comprising:
a data acquisition unit which acquires the reference color data, and stores the acquired reference color data in the storage unit.
